(19) United States
(12) Patent Application Publication
(10) Pub. No.: US 2006/0153446 A1
(43) Pub. Date: Jul. 13, 2006

(54) Black/white stretching system using R G B information in an image and method thereof

(76) Inventors: Jae-hwan Oh, Suwon-si (KR); Jae-seung Kim, Yongin-si (KR); Dong-soo Koo, Suwon-si (KR)

Correspondence Address: STANZIONE & KIM, LLP, 919 18TH STREET, N.W., SUITE 440, WASHINGTON, DC, 20006, US

(21) Appl. No.: 11/290,591

(22) Filed: Dec. 1, 2005

(30) Foreign Application Priority Data
Jan. 10, 2005 (KR) 2005-2015

(51) Int. Cl. G06K 9/00

(52) U.S. Cl. 382/169

(57) ABSTRACT

A black/white stretching system using R, G, B information and a method thereof. The black/white stretching system includes a first transformer to transform a luminance value and a color difference value of an input image to R, G, B values of each pixel, a histogram estimator to estimate a histogram distribution by accumulating each of the transformed R, G, B values of each pixel of the input image with a same weight, a mapper to generate mapped R′, G′, B′ values by mapping the transformed R, G, B values according to a mapping function generated based on the estimated histogram distribution, and a second transformer to generate an output image by reverse-transforming the mapped R′, G′, B′ values from the mapper to an updated luminance signal and an updated color difference signal. Therefore, the black/white stretching system prevents color distortion generated in a primary color image using only luminance information.

### CROSS-REFERENCE TO RELATED APPLICATIONS

This application claims the benefit of Korean Patent Application No. 2005-2015, filed Jan. 10, 2005, in the Korean Intellectual Property Office, the disclosure of which is incorporated herein by reference in its entirety.

### BACKGROUND OF THE INVENTION

1. Field of the Invention

The present general inventive concept relates to a black/white stretching system in an image processing system and a method thereof, and more particularly, to a black/white stretching system to improve contrast of an image and to prevent color distortion generated in a primary color image by using red, green, and blue (R G B) color information of an input image.

2. Description of the Related Art

Contrast of an image represents luminance differences between a darkest area in an image and a brightest area in the image. The image looks clearer when the image has a wider contrast area.

In order to improve the contrast of the image, a histogram equalization scheme is used. The histogram equalization scheme analyzes a histogram of an input image and performs a mapping process to uniformly distribute the histogram to improve the contrast of the input image.

The histogram shows a distribution of gray levels in the input image. The histogram is a graph having a horizontal axis denoting gray levels and a vertical axis denoting a number of pixels corresponding to each gray level for schematically expressing a distribution of color depth in the input image. An image having a higher gray level is a bright image, and an image having a low gray level is a dark image.

Generally, a black/white system is a system that increases a resolution and contrast ratio by stretching a dynamic range of an image signal level to be close to a hardware range.

A conventional black/white stretching system is described in Korean Patent Application entitled “BLACK/WHITE SYSTEM FOR IMPROVING CONTRAST OF IMAGE AND METHOD THEREOF”. However, the conventional black/white system processes only a luminance signal without using information of a color signal. Therefore, the color signal is distorted and degraded when a corresponding color image is displayed. The color signal is generally distorted even more when a contrast of an image having many red and blue color images increases. For example, when an image of a red apple expressed as a primary red color is processed by the conventional black/white stretching system to increase the contrast of the image, a luminance value of the red apple is decreased, because the red apple has a low luminance value. That is, the red color is distorted by the conventional black/white stretching system.

### SUMMARY OF THE INVENTION

The present general inventive concept provides a black/white stretching system to improve contrast of an image and to prevent color distortion generated in primary colored image by using R G B information of the image and a method thereof.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a black/white stretching system using red (R), green (G), blue (B) information of an image, the system including a first transformer to transform a luminance value (Y) and a color difference value of an input image to R, G, B values of each pixel, a histogram distribution estimator to estimate a histogram distribution by accumulating each of the transformed R, G, B values of the pixels of the input image with a same weight, a mapper to generate mapped R′, G′, B′ values by mapping the transformed R, G, B values according to a predetermined mapping function generated based on the estimated histogram distribution, and a second transformer to generate an output image by reverse-transforming the mapped R′, G′, B′ values from the mapper to an updated luminance signal and an updated color difference signal.

The black/white stretching system may further include, a black/white area calculator to calculate a black area to be stretched to a 0 pixel value and a white area to be stretched to a 255 pixel value by using the estimated histogram distribution, and a mapping function calculator to calculate the mapping function based on a maximum value of the calculated black area, a minimum value of the calculated white area, and a plurality of predetermined thresholds.

Each of the calculated black area and the calculated white area may occupy 1.5 to 1.6% of an entire area of the estimated histogram distribution.

The plurality of predetermined thresholds may have a value between the maximum value of the calculated black area and the minimum value of the calculated white area, and may be variable according to an input.

The foregoing and/or other aspects of the present general inventive concept are also achieved by providing an apparatus to stretch a black/white contrast range, comprising a transformer to convert a luminance and a color difference of at least one pixel of an image signal to a plurality of gray levels that correspond to a plurality of color components in the at least one pixel, and the plurality of gray levels are between a black value and a white value, a mapper to adjust gray levels outside an intermediate gray level range to one of the black value and the white value, and an output unit to output an image signal including the at least one pixel having the adjusted gray levels.

The foregoing and/or other aspects of the present general inventive concept are also achieved by providing an apparatus to increase contrast in a black and white image derived from a color image signal, comprising a gray level determination unit to determine gray levels of pixels based on a luminance signal of the pixels and a color difference signal of the pixels, and a mapper to map the determined gray levels to increase the contrast of the black and white image containing the pixels.

The foregoing and/or other aspects of the present general inventive concept are also achieved by providing a black/white stretching method using R, G, B information of an image including transforming a luminance value (Y) and a color difference value of an input image to R, G, B values of each pixel, estimating a histogram distribution by accumulating each of the transformed R, G, B values of each pixel of the input image with a same weight, generating mapped R′, G′, B′ values by mapping the transformed R, G, B values according to a predetermined mapping function generated based on the estimated histogram distribution, and generating an output image by reverse-transforming the mapped R′, G′, B′ values to an updated luminance signal and an updated color difference signal.

The black/white stretching method may further include calculating a black area to be stretched to a 0 pixel value and a white area to be stretched to a 255 pixel value by using the estimated histogram distribution, and calculating the mapping function based on a maximum value of the calculated black area, a minimum value of the calculated white area, and a plurality of predetermined thresholds.

Each of the calculated black area and the calculated white area may occupy 1.5 to 1.6% of an entire area of the estimated histogram distribution.

The plurality of predetermined thresholds may have a value between the maximum value of the calculated black area and the minimum value of the calculated white area, and may be variable according to an input.

The foregoing and/or other aspects of the present general inventive concept are also achieved by providing a method of improving contrast in a two tone image reproducing apparatus, the method comprising receiving an input image signal having a plurality of pixels with a plurality of color component values and deriving a plurality of gray level values in a predetermined range to correspond with the plurality of pixels from the plurality of color component values, mapping first gray level values among the derived plurality of gray level values that are less than a first threshold to a minimum gray level value and mapping second gray level values among the derived plurality of gray level values that are greater than a second threshold to a maximum gray level value, and outputting an image signal having the plurality of pixels including pixels having the mapped gray level values.

The foregoing and/or other aspects of the present general inventive concept are also achieved by providing a method of stretching a black/white contrast range, the method comprising converting a luminance and a color difference of at least one pixel of an image signal to a plurality of gray levels that correspond to a plurality of color components in the at least one pixel, and the plurality of gray levels are between a black value and a white value, adjusting gray levels outside an intermediate gray level range to one of the black value and the white value, and outputting an image signal including the at least one pixel having the adjusted gray levels.

The foregoing and/or other aspects of the present general inventive concept are also achieved by providing a method of increasing contrast in a black and white image obtained from a color image signal, the method comprising determining gray levels of pixels based on a luminance signal of the pixels and a color difference signal of the pixels, and mapping the determined gray levels to increase the contrast of the black and white image containing the pixels.

The foregoing and/or other aspects of the present general inventive concept are also achieved by providing a computer readable medium containing executable code to increase contrast in a black and white image obtained from a color image signal, the medium comprising a first executable code to determine gray levels of pixels based on a luminance signal of the pixels and a color difference signal of the pixels, and a second executable code to map the determined gray levels to increase the contrast of the black and white image containing the pixels.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a black/white stretching system using R G B information of an image according to an embodiment of the present general inventive concept;

FIG. 2 is a flowchart illustrating a black/white stretching method using R G B information of an image according to an embodiment of the present general inventive concept;

FIG. 3 is a view illustrating R G B information of each pixel that is transformed by a first transformer of the black/white stretching system of FIG. 1;

FIG. 4 is a graph illustrating a histogram distribution to estimate a histogram distribution accumulated for each R G B image in a histogram distribution estimator of the black/white stretching system of FIG. 1;

FIG. 5 is a graph illustrating a black area and a white area in an estimated histogram distribution; and

FIG. 6 is a graph illustrating a mapping function according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

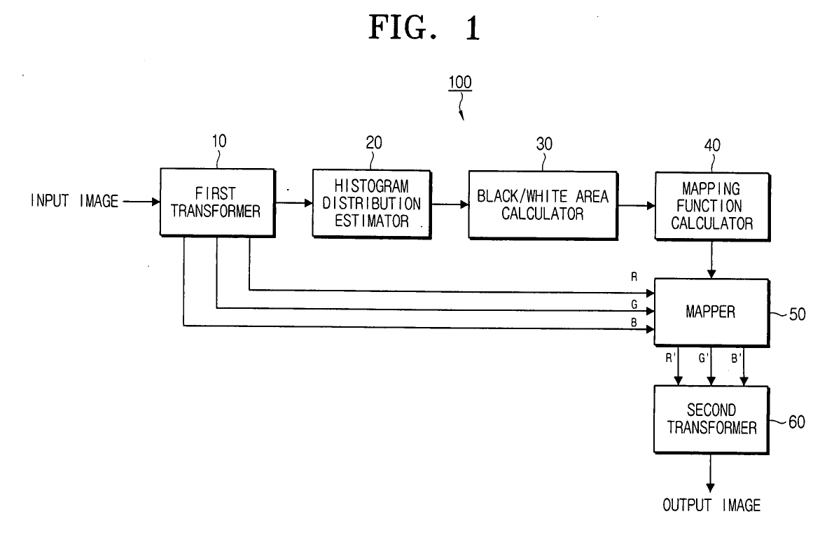

FIG. 1 is a block diagram illustrating a black/white stretching system 100 using R G B information of an image according to an embodiment of the present general inventive concept.

Referring to FIG. 1, the black/white stretching system 100 includes a first transformer 10, a histogram distribution estimator 20, a black area/white area calculator 30, a mapping function calculator 40, a mapper 50, and a second transformer 60.

The first transformer 10 transforms a luminance signal (Y) and a color difference signal (Cb, Cr) of an input signal to an R G B image signal for each pixel. The color difference signal (Cb, Cr) typically indicates how much of a blue component Cb and a red component Cr there is relative to the luminance signal (Y). The red component Cr and the blue component Cb of the color difference signal (Cb, Cr) are also commonly represented by “R-Y” and “B-Y,” respectively. The color difference signal (Cb, Cr) may be mathematically derived from the R G B image signal. A green component typically does not need to be represented, since it can be derived from the luminance signal (Y), the red component Cr, and the blue component Cb. However, it should be understood that this description is not intended to limit the scope of the present general inventive. The color difference signal (Cb, Cr) may be represented in other manners and may have a green component in addition to (or instead of) the blue and red components Cb and Cr.

The histogram distribution estimator 20 estimates a histogram distribution or a probability density function (PDF) distribution, which is accumulated according to each R G B image in the R G B image signal provided by the first transformer 10.

The black/white area calculator 30 calculates a black area to be stretched to a 0 pixel value (i.e., a 0 gray level) and a white area to be stretched to a 255 pixel value (i.e., a 255 gray level) by using the estimated histogram distribution provided by the histogram distribution estimator 20. A boundary value of the black area is defined as a maximum black value (Max_Black) and a boundary value of the white area is defined as a minimum white value (Min_White).

The mapping function calculator 40 calculates a mapping function based on the maximum black value (Max_Black) and the minimum white value (Min_White).

The mapper 50 generates an updated (i.e., new) R G B image signal including updated R G B information by applying the mapping function calculated in the mapping function calculator 40 to the R G B image signal having original R G B information provided by the first transformer 10.

The second transformer 60 generates an output image by receiving the updated R G B information mapped by the mapping function (i.e., R′, G′, B′ image signals) and reverse-transforming the R′, G′, B′ image signals to an updated luminance signal and an updated color difference signal.

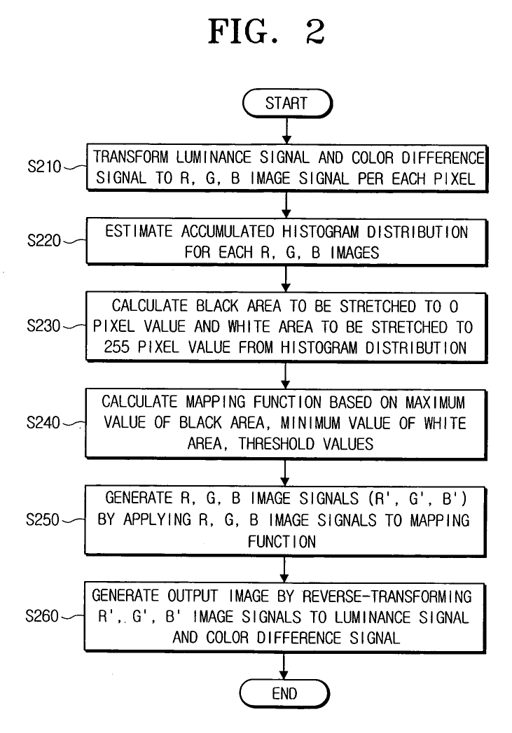

FIG. 2 is a flowchart illustrating a black/white stretching method using the R G B information of an image according to an embodiment of the present general inventive concept. The method of FIG. 2 may be performed by the black/white stretching system 100 of FIG. 1. Accordingly, for illustration purposes, the method of FIG. 2 is described below with reference to FIGS. 1 and 2.

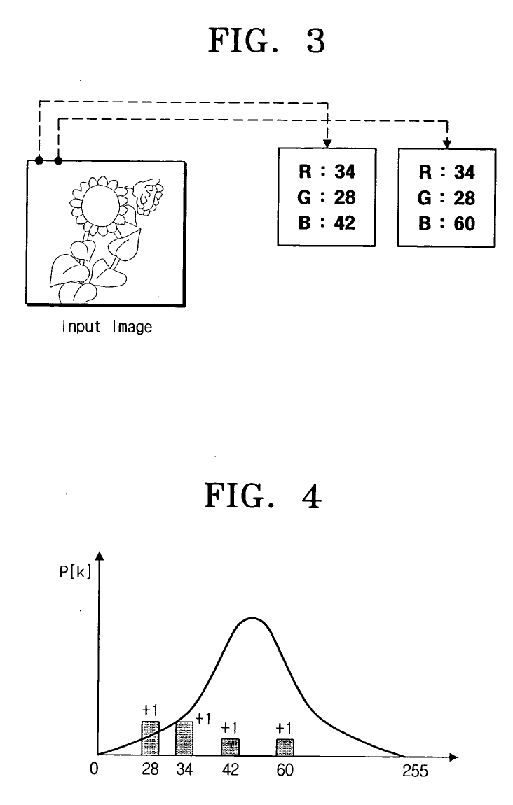

Referring to FIGS. 1 and 2, the first transformer 10 transforms the luminance signals (Y) and the color difference signal (Cb, Cr) to the R G B image signal for each pixel in operation S210. FIG. 3 is a view illustrating the R G B information for each pixel that is transformed by the first transformer 10. In particular, FIG. 3 illustrates two different R G B image signals for two pixels each having an R component, a G component, and a B component that are determined by the first transformer 10 at the operation 210.

Transforming the luminance signal (Y) and the color difference signal (Cb, Cr) to the R, G, B image signals should be known to those skilled in the art. Therefore, a detailed explanation thereof will not be provided. The first transformer 10 may use a consultative committee for international radio (CCIR) 601-1 transforming method. However, it should be understood that other transforming methods may also be used by the first transformer 10 to transform the luminance signal (Y) and the color difference signal (Cb, Cr) to the R, G, B image signals. According to the CCIR 601-1 transforming method, the luminance signal (Y) and the color difference signal (Cb, Cr) of the input image is transformed to the R, G, B image signals by following equations.
R=1.00000Y+1.40200Cr
G=1.00000Y−0.34414Cb−0.71414Cr
B=1.00000Y+1.77200Cb

The histogram distribution estimator 20 estimates the histogram distribution (or probability density function: PDF) accumulated according to each of the R, G, B images provided by the first transformer 10 at operation S220. In other words, the histogram distribution estimator 20 estimates the histogram distribution by accumulating each of R, G, B values provided by the first transformer 10 based on a same weight.

FIG. 4 is a graph illustrating an example of estimating the histogram distribution accumulated for each of the R, G, B images in the histogram distribution estimator 20.

Referring to FIG. 4, the histogram distribution estimated in the histogram distribution estimator 20 may be calculated by following equations.
p[k]+=1
when (R(i,j)=k) or (G(i,j)=k) or (B(i,j)=k)
for @(i,j)H R, G, B Equation 1

In Equation 1, k represents a pixel value that corresponds to a gray value, p[ ] represents a probability density function (PDF), that is, the histogram distribution. The histogram distribution determines a pixel value (between 0 and 255), which corresponds to a gray level value, for all the R, G, B image signals of all the pixels of the input signal and determines a weight for each pixel value between 0 and 255 according to a number of pixels of the R, G, B image signals that have each pixel value that correspond to each gray level value. For example, if thirteen pixels in the R, G, B image signals of the input signal have the pixel value 75, a corresponding weight of 13 may be selected for the pixel value 75. Thus, the estimated histogram distribution indicates a frequency of the pixel values that correspond to gray level values.

The black/white area calculator 30 calculates black areas stretched to the 0 pixel value and white areas stretched to the 255 pixel value by using the estimated histogram distribution at the histogram estimator 20 in operation S230.

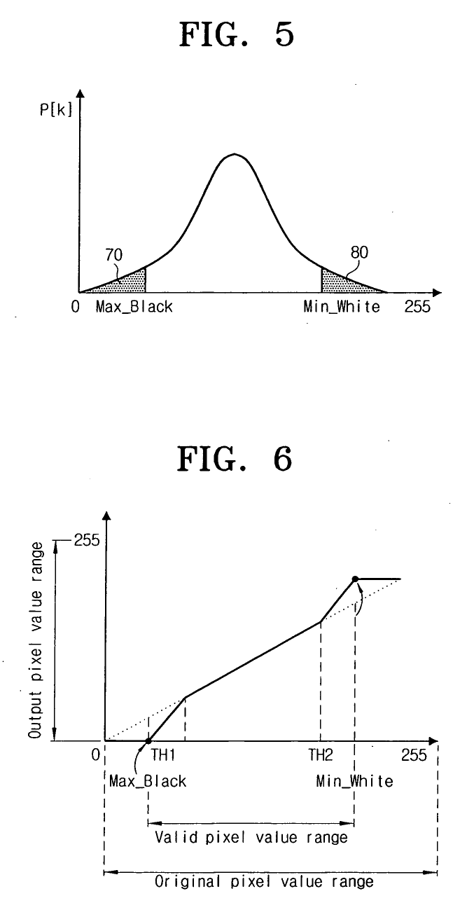

FIG. 5 is a graph illustrating a black area 70 and a white area 80 in the estimated histogram distribution.

Referring to FIG. 5, each of a black area 70 and a white area 80 is calculated to occupy 1.5 to 1.6% of an entire area of the histogram distribution. Hereinafter, a boundary value of the black area 70 is defined as a maximum black value (Max_Black), and a boundary value of the white area 80 is defined as a minimum white value (Min_White).

The mapping function calculator 40 calculates a mapping function based on the maximum black value (Max_Black), the minimum white value (Min_White), and a plurality of thresholds (TH1, TH2) in operation S240.

FIG. 6 is a graph illustrating a mapping function according to an embodiment of the present general inventive concept.

Referring to FIG. 6, the first threshold (TH1) is a value that is greater than the maximum black value (Max_Black), and the second threshold (TH2) is a value that is less than the minimum white value (Min_White). Additionally, the first threshold (TH1) and the second threshold (TH2) may be variable parameters that are changeable by a user.

The first threshold (TH1) may be set to a gray level value of 100 and the second threshold (TH2) may be set to a gray level value of 192. For example, in this case, pixel values having gray level values between 101 and 191 are output as is, pixel values having gray level values between 0 and 100 are mapped to the 0 gray level value (i.e., black), and pixel values between 192 and 255 are mapped to the 255 gray level value (i.e., white). If the first threshold (TH1) and the second threshold (TH2) are optimally set, the mapping function calculator 40 generates the mapping function to output an image that does not burden the human eye and is without excessive color and brightness distortion.

The mapper 50 generates mapped R, G, B information (i.e., updated R, G, B information) by applying the R, G, B information provided by the first transformer 10 to the mapping function calculated by the mapping function calculator 40 in operation S250. That is, the mapper 50 generates the mapped R, G, B information by using the following equations.
R′(i,j)=MF[R(i,j)]
G′(i,j)=MF[G(i,j)]
B′(i,j)=MF[B(i,j)] Equation 2

In Equation 2, (i,j) represents an x-coordinate and a y-coordinate of each pixel. MF[ ] is the mapping function generated in the mapping function calculator 40. R′(i,j), G′(i,j), B′(i,j) represent the mapped R, G, B information converted by the mapper 50, respectively.

The second transformer 60 receives R′, G′, B′ image signals from the mapper 50, which are updated R, G, B information mapped by the mapping function, and generates an output image by reverse-transforming the R′, G′, B′ image signals to a luminance signal (Y′) and a color difference signal (Cb′, Cr′) in operation S260.

Reverse-transforming methods should be known to those skilled in the art. Accordingly, a description thereof will not be provided. If a reverse transforming method CCIR 601-1 is used in the second transformer 60, the following equations may be used.
Y=0.29900R+0.58700G+0.11400B
Cb=−0.16874R−0.33126G+0.50000B
Cr=0.50000R−0.41869G−0.08131B

As described above, a black/white stretching system according to various embodiments of the present general inventive concept improve a contrast ratio of an image by stretching a gradation representing dark areas and a gradation representing bright areas.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software.

Furthermore, a black/white stretching system according to various embodiments of the present general inventive concept prevent color distortion generated in a primary color image by performing a black/white stretching process using R G B information of an input image as compared to the conventional black/white stretching system, which only uses luminance information of the input image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A black/white stretching system that uses red (R), green (G), blue (B) information of an image, the stretching system comprising:
a first transformer to transform a luminance value (Y) and a color difference value of an input image to R, G, B values of each pixel;
a histogram distribution estimator to estimate a histogram distribution by accumulating each of the transformed R, G, B values of each pixel in the input image with a same weight;
a mapper to generate mapped R′, G′, B′ values by mapping the transformed R, G, B values to the mapped R, G′, B′ values using a predetermined mapping function generated based on the estimated histogram distribution; and
a second transformer to generate an output image by reverse-transforming the mapped R′, G′, B′ values from the mapper to an updated luminance signal and an updated color difference signal.

2. The black/white stretching system of claim 1, further comprising:
a black/white area calculator to calculate a black area to be stretched to a 0 pixel value and a white area to be stretched to a 255 pixel value by using the estimated histogram distribution; and
a mapping function calculator to calculate the mapping function based on a maximum value of the calculated black area, a minimum value of the calculated white area, and a plurality of predetermined thresholds.

3. The black/white stretching system of claim 2, wherein each of the black area and the white area occupies 1.5 to 1.6% of an entire area of the estimated histogram distribution.

4. The black/white stretching system of claim 2, wherein the plurality of predetermined thresholds have a value between the maximum value of the black area and the minimum value of the white area, and are variable according to an input.

5. An apparatus to stretch a black/white contrast range, comprising:
a transformer to convert a luminance and a color difference of at least one pixel of an image signal to a plurality of gray levels that correspond to a plurality of color components in the at least one pixel, and the plurality of gray levels are between a black value and a white value;
a mapper to adjust gray levels outside an intermediate gray level range to one of the black value and the white value; and
an output unit to output an image signal including the at least one pixel having the adjusted gray levels.

6. The apparatus of claim 5, further comprising:
a black white area calculator to set a first percentage of input gray levels to be set to the black value and a second percentage of the input gray levels to be set to the white value,
wherein the mapper adjusts the gray levels outside the intermediate gray level range by setting boundaries of the intermediate gray level range such that the first percentage of the input gray levels fall below the intermediate gray level range and the second percentage of the input gray levels fall above the intermediate gray level range.

7. The apparatus of claim 5, wherein the plurality of color components of the at least one pixel comprise red, green, and blue components and the gray levels range between a 0-black value and a 255-white value.

8. An apparatus to increase contrast in a black and white image obtained from a color image signal, comprising:
a gray level determination unit to determine gray levels of pixels based on a luminance signal of the pixels and a color difference signal of the pixels; and
a mapper to map the determined gray levels to increase the contrast of the black and white image containing the pixels.

9. The apparatus of claim 8, wherein the mapper compares the determined gray levels to a plurality of thresholds and maps a first plurality of gray levels to a black gray level, a second plurality of gray levels to a white gray level, and outputs a third plurality of gray levels without changing them.

10. The apparatus of claim 9, further comprising:
a black/white area calculator to enable a user to set the plurality of thresholds.

11. The apparatus of claim 9, wherein the plurality of thresholds are set to a gray level of 100 and a gray level of 192 such that the first plurality of gray levels are less than or equal to 100, the second plurality of gray levels are greater than or equal to 192, and the third plurality of gray levels are between 100 and 192.

12. The apparatus of claim 8, wherein the mapper maps gray levels that are close to a black gray level to the black gray level and maps gray levels that are close to a white gray level to the white gray level.

13. A method of improving contrast in a two tone image reproducing apparatus, the method comprising:
receiving an input image signal having a plurality of pixels with a plurality of color component values and deriving a plurality of gray level values in a predetermined range to correspond with the plurality of pixels from the plurality of color component values;
mapping first gray level values among the derived plurality of gray level values that are less than a first threshold to a minimum gray level value and mapping second gray level values among the derived plurality of gray level values that are greater than a second threshold to a maximum gray level value; and
outputting an image signal having the plurality of pixels including pixels having the mapped gray level values.

14. A method of stretching a black/white contrast range, the method comprising:
converting a luminance and a color difference of at least one pixel of an image signal to a plurality of gray levels that correspond to a plurality of color components in the at least one pixel, and the plurality of gray levels are between a black value and a white value;
adjusting gray levels outside an intermediate gray level range to one of the black value and the white value; and
outputting an image signal including the at least one pixel having the adjusted gray levels.

15. The method of claim 14, further comprising:
setting a first percentage of input gray levels to be set to the black value and a second percentage of the input gray levels to be set to the white value,
wherein the adjusting of the gray levels outside the intermediate gray level range comprises setting boundaries of the intermediate gray level range such that the first percentage of the input gray levels fall below the intermediate gray level range and the second percentage of the input gray levels fall above the intermediate gray level range.

16. The method of claim 14, wherein the plurality of color components of the at least one pixel comprise red, green, and blue components and the gray levels range between a 0-black value and a 255-white value.

17. A method of increasing contrast in a black and white image derived from a color image signal, the method comprising:
determining gray levels of pixels based on a luminance signal of the pixels and a color difference signal of the pixels; and
mapping the determined gray levels to increase the contrast of the black and white image containing the pixels.

18. The method of claim 17, wherein the mapping of the determined gray levels comprises comparing the determined gray levels to a plurality of thresholds and mapping a first plurality of gray levels to a black gray level, a second plurality of gray levels to a white gray level, and outputting a third plurality of gray levels without changing them.

19. The method of claim 18, further comprising:
enabling a user to set the plurality of thresholds.

20. The method of claim 18, wherein the plurality of thresholds are set to a gray level of 100 and a gray level of 192 such that the first plurality of gray levels are less than or equal to 100, the second plurality of gray levels are greater than or equal to 192, and the third plurality of gray levels are between 100 and 192.

21. The method of claim 17, wherein the mapping of the determined gray levels comprises mapping gray levels that are close to a black gray level to the black gray level and maps gray levels that are close to a white gray level to the white gray level.

22. A black/white stretching method using R, G, B information of an image, the method comprising:
transforming a luminance value (Y) and a color difference value of an input image to R, G, B values of each pixel;
estimating a histogram distribution by accumulating each of the transformed R, G, B values of each pixel in the input image with a same weight;
generating mapped R′, G′, B′ values by mapping the transformed R, G, B values according to a predetermined mapping function generated based on the estimated histogram distribution; and
generating an output image by reverse-transforming the mapped R′, G′, B′ values to an updated luminance signal and an updated color difference signal.

23. The black/white stretching method of claim 22, further comprising:
calculating a black area to be stretched to a 0 pixel value and a white area to be stretched to a 255 pixel value by using the estimated histogram distribution; and
calculating the mapping function based on a maximum value of the calculated black area, a minimum value of the calculated white area, and a plurality of predetermined thresholds.

24. The black/white stretching method of claim 23, wherein each of the black area and the white area occupies 1.5 to 1.6% of an entire area of the estimated histogram distribution.

25. The black/white stretching method of claim 23, wherein the plurality of predetermined thresholds have a value between the maximum value of the calculated black area and the minimum value of the calculated white area, and are variable according to an input.

26. A computer readable medium containing executable code to increase contrast in a black and white image derived from a color image signal, the medium comprising:
a first executable code to determine gray levels of pixels based on a luminance signal of the pixels and a color difference signal of the pixels; and
a second executable code to map the determined gray levels to increase the contrast of the black and white image containing the pixels.
